(19) United States
(12) Patent Application Publication
(10) Pub. No.: US 2010/0107050 A1
(43) Pub. Date: Apr. 29, 2010

(54) DIGITAL PHOTO FRAME WITH ANNOTATION FUNCTION AND METHOD THEREOF

(75) Inventors: CHUAN-HONG WANG, Tu-Cheng (TW); HSIAO-CHUNG CHOU, Tu-Cheng (TW); LI-ZHANG HUANG, Tu-Cheng (TW); KUAN-HONG HSIEH, Tu-Cheng (TW); XIAO-GUANG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/434,680

(22) Filed: May 3, 2009

(30) Foreign Application Priority Data
Oct. 24, 2008 (CN) 200810305170.5

(51) Int. Cl. G06F 17/00

(52) U.S. Cl. 715/232; 715/233; 715/230; 715/768; 345/173

(57) ABSTRACT

A digital photo frame (DPF) with annotation function and a method thereof are provided. The method includes steps of: reading a to-be-displayed original photo; displaying the read original photo; receiving touch operations on the touch screen; generating an annotation interface on the original photo in response to the touch operations, identifying an annotations corresponding to the touch operations, and displaying the annotations on the annotation interface; making the annotations overlaying on the original photo; displaying the overlaid photo.

### BACKGROUND

1. Technical Field

The present disclosure relates to a digital photo frame (DPF) capable of annotating photos and method thereof.

2. Description of Related Art

In the past people would make notes on the back of photographs to preserve their memories. Now, however, with the introduction of digital photos and DPF's, there is no convenient way to do this.

Therefore, what is needed is a digital photo frame capable of annotating photos and a method thereof.

### BRIEF DESCRIPTION OF THE DRAWINGS

FIG. 1 is a block diagram of the hardware infrastructure of a digital photo frame, in accordance with an exemplary embodiment.

FIG. 2 is a flowchart of a photo annotation method implemented by the digital photo frame of FIG. 1, in accordance with an exemplary embodiment.

### DETAILED DESCRIPTION OF THE EMBODIMENTS

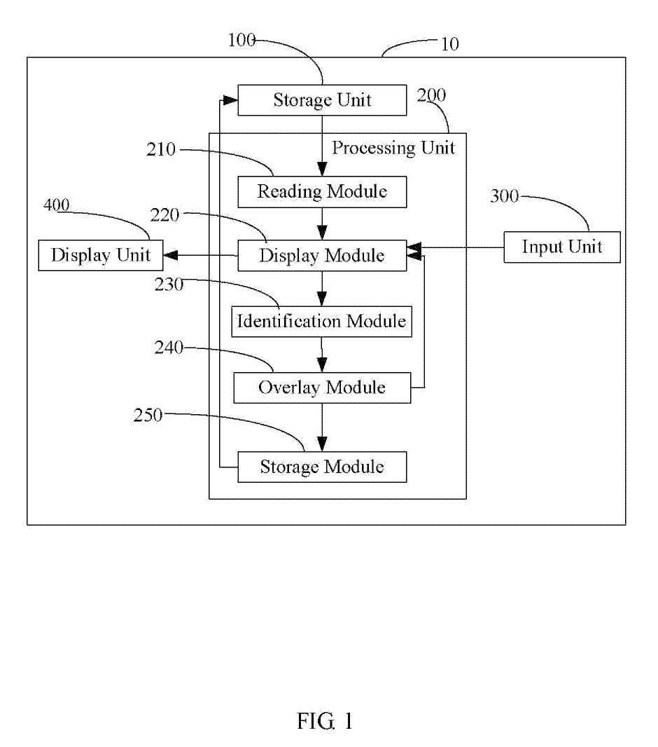

FIG. 1 is a block diagram of the hardware infrastructure of a digital photo frame in accordance with an exemplary embodiment. The digital photo frame 10 includes a storage unit 100, a processing unit 200, an input unit 300, and a display unit 400. The storage unit 100 is configured to store photos. The display unit 400 is configured to display the photos. In the exemplary embodiment, the display unit 400 is a touch screen. The input unit 300 is configured to receive touch operations on the display unit 400, for example, when a user touches the screen with a finger or stylus.

The processing unit 200 includes a reading module 210, a display module 220, an identification module 230, an overlay module 240, and a storage module 250.

The reading module 210 is configured to read an original photo from the storage unit 100.

The identification module 230 is configured to generate an annotation interface on the original photo in response to the touch operations from the input unit 300, identify an annotation corresponding to the touch operations, and display the annotation on the annotation interface. In the exemplary embodiment, the annotation interface can be used to input text, drawings etc. The annotation interface can be pre-programmed to open as a window of a default size overlaying a portion of the image to be annotated. Then the annotation interface can be expanded or shrank to fit the annotations entered by the user. In addition, the position of the annotation interface in the original photo can be changed by the user, using for example a sliding touch on an edge of the annotation interface to drag the annotation interface to a desired position overlaying the image. Furthermore, the touch screen 400 employs an OCR (Optical Character Recognition) technology to identify the annotations on the annotation interface. However it should be noted that, in other exemplary embodiments, the touch screen 400 could also use some other technology to identify the annotations on the annotation interface.

The overlay module 240 is configured to make the annotation interface becoming transparent leaving only the annotations overlaying the image, or attractively design the annotation interface overlaying on the image along with the annotations to provide a contrasting background for the annotations.

The display module 220 is configured to display the read original photo and overlaid photos on the display unit 400.

The storage module 250 is configured to store the overlaid photo either as a new file or to replace the original photo.

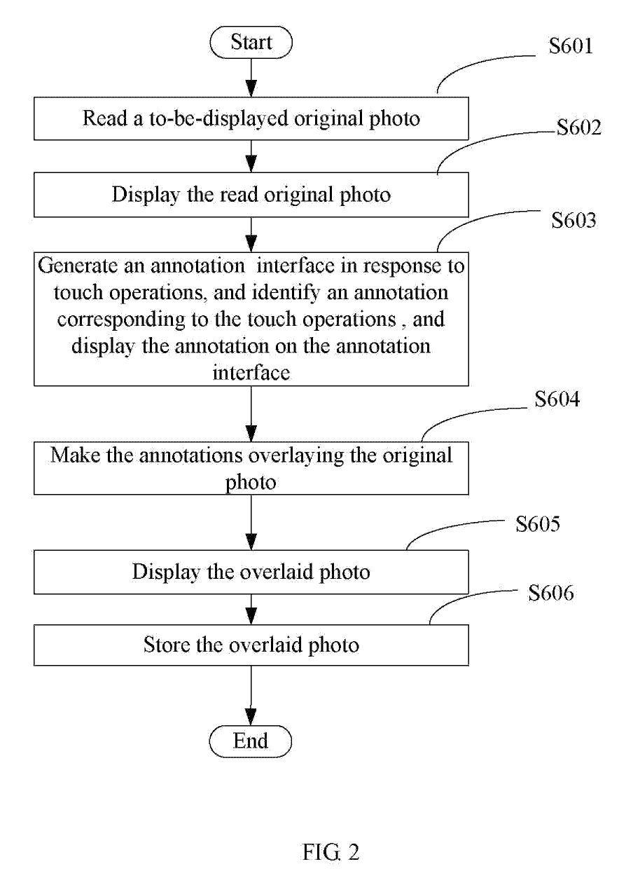

FIG. 2 is a flowchart of a photo annotating method implemented by the digital photo frame of FIG. 1 in accordance with an exemplary embodiment.

In step S601, the reading module 210 reads a to-be-displayed original photo from the storage unit 100.

In step S602, the display module 220 displays the read original photo on the display unit 400.

In step S603, the identification module 230 generates an annotation interface on the original photo in response to the touch operations from the input unit 300, identifies an annotation corresponding to the touch operations, and displays the annotation on the annotation interface.

In step S604, the overlay module 240 makes the annotation interface becoming transparent leaving only the annotations overlaying the image, or attractively designs the annotation interface overlaying on the image along with the annotations to provide a contrasting background for the annotations.

In step S605, the display module 220 displays the overlaid photos on the display unit 400.

In step S606, the storage module 260 stores the overlaid photo in the storage unit 100 either as a new file or to replace the original photo.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A digital photo frame with annotation function, comprising:
a storage unit;
an input unit;
a display unit capable for displaying the photos of the digital photo frame, wherein the display unit is a touch screen;
a processing unit comprising:
a reading module capable of reading a to-be-displayed original photo from the storage unit;
an identification module capable of generating an annotation interface on the original photo in response to touch operations from the input unit, identifying an annotation corresponding to the touch operations, and displaying the annotation on the annotation interface;
a overlay module capable of making the annotations overlaying on the original photo;
a display module capable of displaying the read original photo and overlaid photo on the display unit;

2. The digital photo frame as in claim 1, wherein the annotation interface can be used to input text, drawings, or a combination of text and drawings.

3. The digital photo frame as in claim 1, wherein the position of the annotation interface in the original photo can be changed by the user.

4. The digital photo frame as in claim 1, wherein the overlay module makes the annotation interface becoming transparent leaving only the annotations overlaying the image.

5. The digital photo frame as in claim 1, wherein the overlay module attractively designs the annotation interface overlaying on the image along with the annotations to provide a contrasting background for the annotations.

6. The digital photo frame as in claim 1, wherein the processing unit further comprises a storage module, the storage module is capable of storing the overlaid photo in the storage unit.

7. A method for annotating photo, comprising:
reading a to-be-displayed original photo;
displaying the read original photo;
receiving touch operations on a touch screen;
generating an annotation interface on the original photo in response to the touch operations, identifying an annotations corresponding to the touch operations, and displaying the annotations on the annotation interface;
making the annotations overlaying on the original photo;
displaying the overlaid photo.

8. The method as described in claim 7, wherein the annotation interface can be used to input text, drawings, or a combination of text and drawings.

9. The method as described in claim 7, wherein the position of the annotation interface in the original photo can be changed by the user.

10. The method as described in claim 7, wherein the overlaying step further comprising:
making the annotation interface becoming transparent leaving only the annotations overlaying the image.

11. The method as described in claim 7, wherein the overlaying step further comprising:
attractively designing the annotation interface overlaying on the image along with the annotations to provide a contrasting background for the annotations.

12. The method as described in claim 7, further comprising:
storing the overlaid photo.
